(19) United States
(12) Patent Application Publication
(10) Pub. No.: US 2025/0369720 A1
(43) Pub. Date: Dec. 4, 2025

(54) BOW HANGER

(71) Applicant: Latitude Outdoors, LLC, Grand Rapids, MI (US)

(72) Inventors: Kevin Leach, Grand Rapids, MI (US); Alex Chopp, Royal Oak, MI (US); Jake Matelic, Royal Oak, MI (US)

(73) Assignee: Latitude Outdoors, LLC, Grand Rapids, MI (US)

(21) Appl. No.: 19/217,176

(22) Filed: May 23, 2025

Related U.S. Application Data
(60) Provisional application No. 63/654,544, filed on May 31, 2024.

(51) Int. Cl. F41B 5/14; F16M 13/02

(52) U.S. Cl. CPC F41B 5/1453; F16M 13/02

(57) ABSTRACT

A hanger includes a support member. A standoff is pivotably coupled to the support member and is operable to pivot relative to the support member between a use position and a stowed position about a standoff pivot axis. A hanger arm is pivotably coupled to the support member and is operable to pivot relative to the support member between an extended position and a retracted position about a hanger arm pivot axis.

### CROSS-REFERENCE TO RELATED APPLICATIONS

This application claims priority to and the benefit under 35 U.S.C. § 119(e) of U.S. Provisional Patent Application No. 63/654,544, filed May 31, 2024, entitled BOW HANGER, the entire disclosure of which is hereby incorporated herein by reference.

### FIELD OF THE DISCLOSURE

The present disclosure generally relates to a hanger. More specifically, the present disclosure relates to a hanger for outdoor recreation or hunting equipment, such as a bow.

### BACKGROUND OF THE DISCLOSURE

Bow hangers for retaining a bow while hunting from a tree stand or saddle are often screwed into a tree.

### SUMMARY OF THE DISCLOSURE

According to a first aspect of the present disclosure, a hanger includes a support member. A standoff is pivotably coupled to the support member and is operable to pivot relative to the support member between a use position and a stowed position about a standoff pivot axis. A hanger arm is pivotably coupled to the support member and is operable to pivot relative to the support member between an extended position and a retracted position about a hanger arm pivot axis.

According to a second aspect of the present disclosure, a hanger includes a support member having a rear side and a front side that is opposite the rear side and that defines a slot configured to receive a strap therein for securing the hanger to a tree. A standoff is pivotably coupled to the support member, extends rearward away from the rear side of the support member, and is operable to pivot relative to the support member between a use position and a stowed position about a standoff pivot axis that extends through the slot. A hanger arm is pivotably coupled to the support member and is operable to pivot relative to the support member between an extended position and a retracted position about a hanger arm pivot axis.

According to a third aspect of the present disclosure, a hanger includes a support member. A standoff is pivotably coupled to the support member and is operable to pivot relative to the support member between a use position and a stowed position about a standoff pivot axis. A hanger arm is pivotably coupled to the support member and is operable to pivot relative to the support member between an extended position and a retracted position about a hanger arm pivot axis, wherein an uppermost portion of the support member is the uppermost portion of the hanger in the use position of the standoff and the extended position of the hanger arm, and the uppermost portion of the support member is lower than a portion of the standoff in the stowed position of the standoff and lower than a portion of the hanger arm in the retracted position of the hanger arm.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a hanger, illustrating a support member, a standoff pivoted relative to the support member to a use position, and a hanger arm pivoted relative to the support member to an extended position, according to one embodiment;

FIG. 2 is a perspective view of the hanger, illustrating the support member, the standoff in the use position, and the hanger arm in the extended position, according to one embodiment;

FIG. 3 is an exploded perspective view of the hanger, illustrating the support member, the standoff, the hanger arm, and a plurality of fasteners, according to one embodiment;

FIG. 4 is a rear perspective view of the hanger, illustrating the standoff in the use position and the hanger arm in the extended position, according to one embodiment;

FIG. 5 is a rear perspective view of the hanger, illustrating the standoff pivoted relative to the support member to a stowed position, and the hanger arm pivoted relative to the support member to a retracted position, according to one embodiment;

FIG. 6 is a side elevational view of the hanger, illustrating the standoff in the use position and the hanger arm in the extended position, according to one embodiment;

FIG. 7 is a side elevational view of the hanger, illustrating the standoff in the stowed position and the hanger arm in the retracted position, according to one embodiment; and

FIG. 8 is a front elevational view of the hanger, illustrating the hanger configured such that the hanger arm is in the retracted position and the standoff is in the stowed position, according to one embodiment.

The components in the figures are not necessarily to scale, emphasis instead being placed upon illustrating the principles described herein.

### DETAILED DESCRIPTION OF THE PREFERRED EMBODIMENTS

Additional features and advantages of the disclosure will be set forth in the detailed description which follows and will be apparent to those skilled in the art from the description, or recognized by practicing the disclosure as described in the following description, together with the claims and appended drawings.

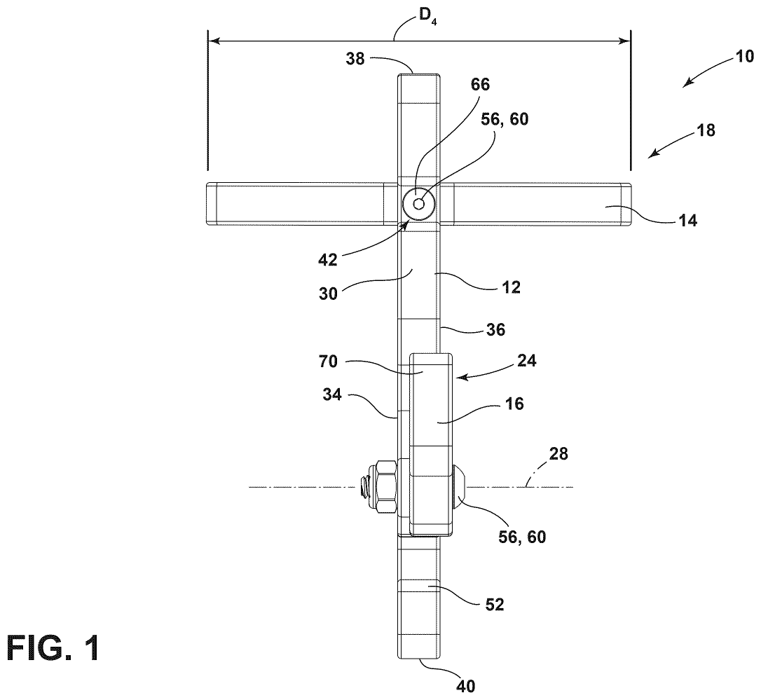

For purposes of description herein, the terms “upper,” “lower,” “right,” “left,” “lateral,” “rear,” “front,” “vertical,” “horizontal,” “upward,” “downward” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. Unless stated otherwise, the term “forward” shall refer to toward the intended viewer and/or closer to the intended viewer based on the context. For example, the phrase “extending forward” shall be interpreted as extending toward the intended viewer, while a first element being “forward of” a second element shall refer to the first element being closer than the second element to the intended viewer. Unless stated otherwise, the term “rearward” shall refer to away from the intended viewer and/or further from the intended viewer based on the context. For example, the phrase “extending rearward” shall be interpreted as extending away from the intended viewer, while a first element being “rearward of” a second element shall refer to the first element being further than the second element from the intended viewer. Unless stated otherwise, the term “lateral” and derivatives thereof shall refer to left-right directions. However, it is to be understood that the disclosure may assume various alternative orientations, except where expressly specified to the contrary. It is also to be understood that the specific devices illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring now to FIGS. 1-8, a hanger 10 includes a support member 12, a standoff 14, and a hanger arm 16. The standoff 14 is pivotably coupled to the support member 12 and operable to pivot relative to the support member 12 between a use position 18 and a stowed position 20 about a standoff pivot axis 22. The hanger arm 16 is pivotably coupled to the support member 12 and is operable to pivot relative to the support member 12 between an extended position 24 and a retracted position 26 about a hanger arm pivot axis 28.

Referring now to FIGS. 1-4, the support member 12 for the hanger 10 may include a front side 30 and a rear side 32 opposite the front side 30. The support member 12 may further include a first lateral side 34 and a second lateral side 36 opposite the first lateral side 34. In the embodiment illustrated in FIGS. 1-4, the front and rear sides 30, 32 of the support member 12 extend between the first and second lateral sides 34, 36 of the support member 12. The support member 12 further includes an uppermost portion 38 and a lowermost portion 40.

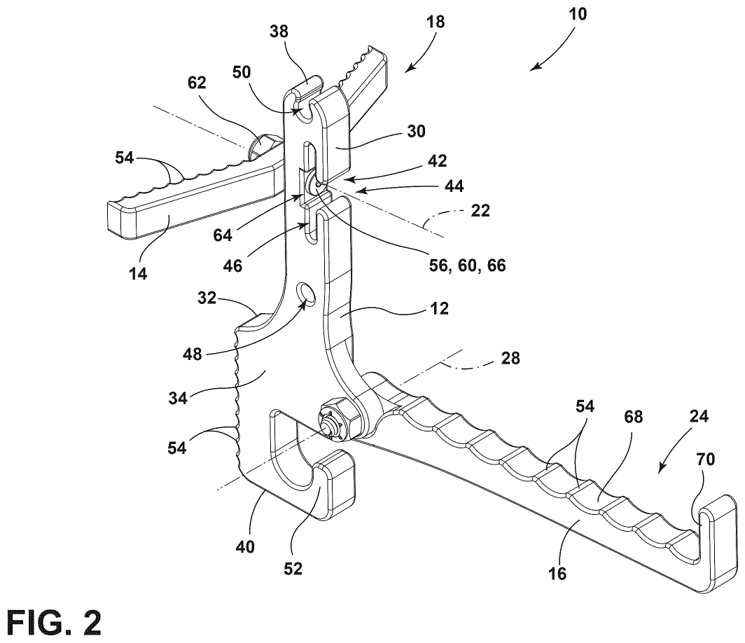

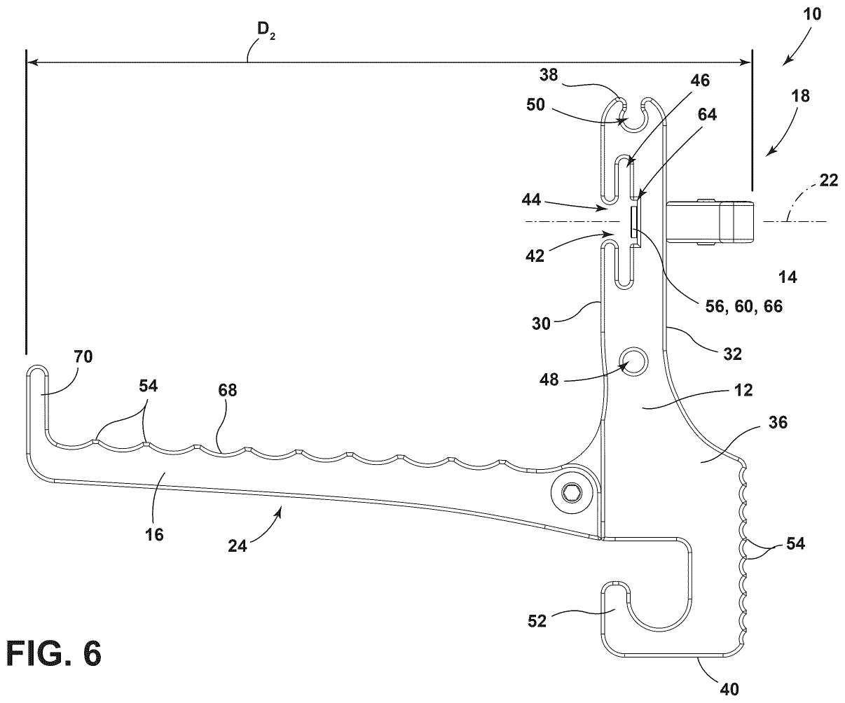

Referring now to FIGS. 1-4 and 6, the support member 12 may define a slot 42 that is configured to receive a strap (not shown) therein for securing the hanger 10 to a tree. In various implementations, the slot 42 is defined on the front side 30 of the support member 12. For example, as illustrated in FIGS. 2, 3, and 6, the slot 42 is defined by the front side 30 of the support member 12. In the illustrated embodiment, the slot 42 includes a relatively narrow opening 44, and then expands upward and downward to define a strap retaining portion 46 that is nearer to the rear side 32 of the support member 12 than the opening 44 to the slot 42, as illustrated in FIG. 6. A variety of types of slots 42 are contemplated. In various embodiments, the standoff pivot axis 22 may extend through the slot 42 defined by the support member 12, as described further herein.

Referring still to FIGS. 1-4 and 6, in some embodiments, the support member 12 may define an aperture 48 and/or a channel 50. As illustrated in FIG. 6, the aperture 48 is positioned downward of the slot 42 and extends through the support member 12 from the first lateral side 34 to the second lateral side 36. As further illustrated in FIG. 6, the channel 50 is positioned upward of the slot 42 proximate to the uppermost portion 38 of the support member 12. In various embodiments, a cord (not shown) is configured to be looped through the aperture 48 and received within the channel 50 defined by the support member 12.

As further illustrated in FIG. 6, in various implementations, the support member 12 may include a hook portion 52. The hook portion 52 may form the lowermost portion 40 of the support member 12 in various embodiments. In the embodiment illustrated in FIG. 6, the hook portion 52 is disposed lower than the hanger arm 16. In the illustrated embodiment, the hook portion 52 does not extend forward beyond the front side 30 of the support member 12. In various embodiments, a portion of the rear side 32 of the support member 12 may be configured to contact a tree to which the hanger 10 is secured in operation of the hanger 10. As illustrated in FIG. 6, the rear side 32 of the support member 12 includes a plurality of ridges 54 that are configured to engage the tree. The ridges 54 extend laterally along the rear side 32 of the support member 12.

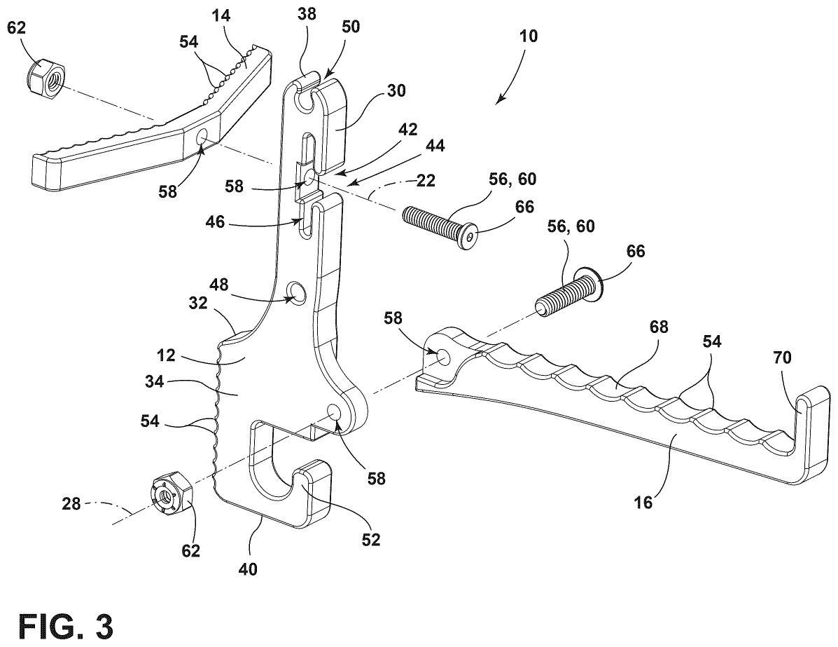

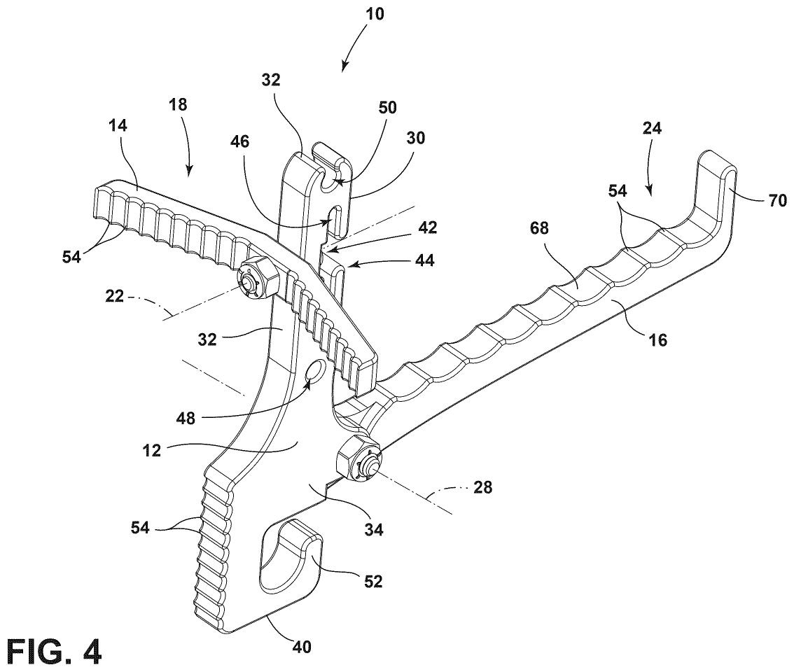

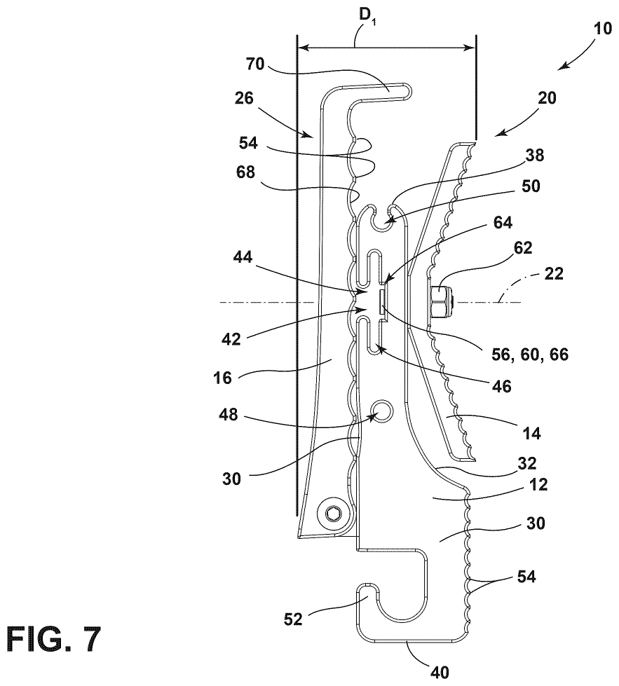

Referring now to FIGS. 1-7, the standoff 14 of the hanger 10 may be pivotably coupled to the support member 12. As illustrated in FIGS. 4-7, in various implementations, the standoff 14 is pivotably coupled to the support member 12 and extends rearward away from the rear side 32 of the support member 12. In various embodiments, the standoff 14 is pivotably coupled to the rear side 32 of the support member 12. In the embodiments illustrated in FIGS. 3-7, the standoff 14 is pivotably coupled to the rear side 32 of the support member 12 via a fastener 56 that extends through a fastener hole 58 defined by the support member 12 and a fastener hole 58 defined by the standoff 14. In the illustrated embodiment, the fastener 58 is a bolt 60, and a nut 62 is threaded onto the bolt 60 to secure the standoff 14 to the support member 12 in pivotable fashion. As illustrated in FIGS. 3 and 7, the fastener hole 58 that extends through the support member 12 originates at a portion of the support member 12 that defines the slot 42. As illustrated in FIGS. 3 and 7, the slot 42 includes a recessed portion 64 that extends toward the rear side 32 of the support member 12 from the strap retaining portion 46 of the slot 42. A head 66 of the fastener 56 is configured to be received within the recessed portion 64 of the slot 42, as illustrated in FIG. 7, such that the head 66 of the fastener 56 does not impede insertion of a strap into the strap retaining portion 46 of the slot 42.

Referring still to FIGS. 1-7, in various embodiments, the standoff 14 is operable to pivot about the standoff pivot axis 22 relative to the support member 12. As illustrated in FIGS. 2-7, the standoff pivot axis 22 may extend through the slot 42 defined by the support member 12, the fastener hole 58 defined by the support member 12, the fastener hole 58 defined by the standoff 14, and/or the fastener 56 that is utilized to pivotably couple the standoff 14 and the support member 12. In various embodiments, the standoff pivot axis 22 is not parallel to the hanger arm pivot axis 28. In some embodiments, the standoff pivot axis 22 is perpendicular to the hanger arm pivot axis 27 as illustrated exemplarily in FIGS. 2-5.

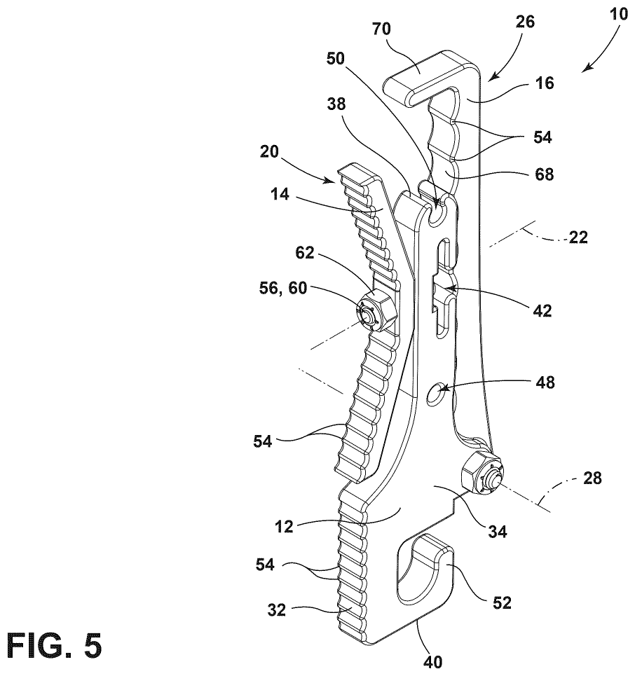

Referring now to FIGS. 1-8, the standoff 14 may be operable to pivot relative to the support member 12 between the use position 18 and the stowed position 20 about the standoff pivot axis 22. In the use position 18 (as illustrated exemplarily in FIGS. 1, 2, 4, and 6), the standoff 14 may have a first lateral footprint and a first vertical footprint. In the stowed position 20 of the standoff 14 (as illustrated exemplarily in FIGS. 5, 7, and 8), the standoff 14 may have a second lateral footprint and a second vertical footprint, wherein the first lateral footprint is larger than the second lateral footprint and the second vertical footprint is larger than the first vertical footprint. In various implementations, the standoff 14 is configured to engage a tree to which the hanger 10 is secured in the use position 18 of the standoff 14, as described further herein.

Referring now to FIGS. 2, 4, and 5, in various embodiments, the standoff 14 may be generally elongated and may have an engagement surface that includes a plurality of ridges 54 for engagement with a tree to which the hanger 10 is attached. In the embodiment illustrated in FIGS. 4 and 5, the standoff 14 is generally V-shaped, and the engagement surface of the standoff 14 faces away from the support member 12. As illustrate FIGS. 4 and 5, the ridges 54 of the engagement surface of the standoff 14 extend vertically in the use position 18 of the standoff 14 and extend laterally in the stowed position 20 of the standoff 14. A variety of types of standoffs 14 having one or more of a variety of shapes are contemplated.

Referring now to FIGS. 1-7, the hanger arm 16 of the hanger 10 may be pivotably coupled to the support member 12 and operable to pivot relative to the support member 12 between the extended position 24, as illustrated exemplarily in FIGS. 1, 2, 4, and 6, and the retracted position 26, as illustrated exemplarily in FIGS. 5, 7, and 8. The hanger arm 16 may be operable to pivot relative to the support member 12 about the hanger arm pivot axis 28. In various implementations, the hanger arm pivot axis 28 extends laterally, as illustrated in FIG. 1. In various embodiments, the hanger arm pivot axis 28 extends perpendicularly to the standoff pivot axis 22. For example, as illustrated in FIG. 2, the hanger arm pivot axis 28 extends laterally, while the standoff pivot axis 22 extends in the fore-aft (forward-rearward) direction.

Referring now to FIGS. 1-8, the hanger arm 16 may have a first fore-aft footprint and a first vertical footprint in the extended position 24. Further, the hanger arm 16 may have a second fore-aft footprint and a second vertical footprint in the retracted position 26, wherein the first fore-aft footprint is larger than the second fore-aft footprint, and the second vertical footprint is larger than the first vertical footprint.

As illustrated in FIG. 2, wherein the hanger arm 16 of the hanger 10 is in the extended position 24, the hanger arm 16 may include a support surface 68 upon which an accessory, such as a bow, is configured to be hung and supported by. In the embodiment illustrated in FIG. 2, the support surface 68 of the hanger arm 16 faces upward in the extended position 24 of the hanger arm 16 and includes a plurality of ridges 54 that extend laterally along the support surface 68 of the hanger arm 16 in the extended position 24. In the illustrated embodiment, the hanger arm 16 includes a tang 70 that extends outward from an end of the hanger arm 16 that is distal from the support member 12 to which the hanger arm 16 is pivotably coupled. The tang 70 extends upward from an adjacent portion of the hanger arm 16 in the extended position 24 of the hanger 10.

Referring now to FIGS. 6 and 7, in some embodiments, the uppermost portion 38 of the support member 12 is the uppermost portion of the hanger 10 in the use position 18 of the standoff 14 and the extended position 24 of the hanger arm 16. For example, as illustrated in FIG. 6, wherein the standoff 14 is in the use position 18 and the hanger arm 16 is in the extended position 24, the uppermost portion 38 of the support member 12 forms the uppermost portion of the hanger 10. In some embodiments, the uppermost portion 38 of the support member 12 is lower than a portion of the standoff 14 in the stowed position 20 of the standoff 14 and/or lower than a portion of the hanger arm 16 in the retracted position 26 of the hanger arm 16. For example, as illustrated in FIG. 7, wherein the standoff 14 is in the stowed position 20 and the hanger arm 16 is in the retracted position 26, the uppermost portion 38 of the support member 12 is disposed lower than a portion of the standoff 14 and lower than a portion of the hanger arm 16.

Referring now to FIGS. 1 and 6-8, in some implementations, with respect to the standoff pivot axis 22, an axial offset between the portion of the hanger 10 defining an axial extreme of the hanger 10 in a first axial direction and the portion of the hanger 10 defining an axial extreme of the hanger 10 in a second axial direction that is opposite the first axial direction is a first distance D₁ in the stowed position 20 of the standoff 14 and the retracted position 26 of the hanger arm 16, as illustrated in FIG. 7. Further, in some implementations, with respect to the standoff pivot axis 22, the axial offset between the portion of the hanger 10 defining the axial extreme of the hanger 10 in the first axial direction and the portion of the hanger 10 defining the axial extreme of the hanger 10 in the second axial direction is a second distance D₂ in the use position 18 of the standoff 14 and the extended position 24 of the hanger arm 16, as illustrated in FIG. 6. In the illustrated embodiment, the first distance D₁ is less than the second distance D₂. In some embodiments, the first distance D₁ is less than or equal to half of the second distance D₂. In some embodiments, the first distance D₁ is less than or equal to a third of the second distance D₂. In some embodiments, the first distance D₁ is less than or equal to a quarter of the second distance D₂.

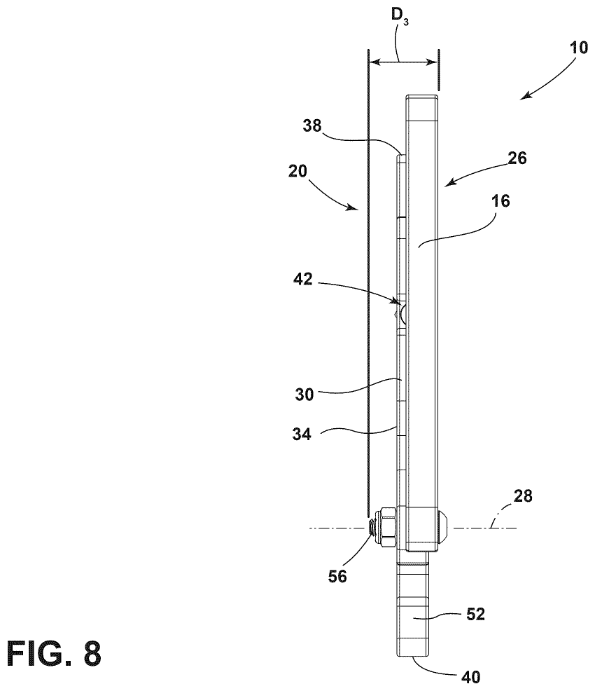

Referring now to FIGS. 1 and 8, in some implementations, with respect to the hanger arm pivot axis 28, the axial offset between the portion of the hanger 10 defining the axial extreme of the hanger 10 in a first axial direction and the portion of the hanger 10 defining the axial extreme of the hanger 10 in a second axial direction that is opposite the first axial direction is a third distance D₃ in the stowed position 20 of the standoff 14 and the retracted position 26 of the hanger arm 16, as illustrated in FIG. 8. Further, in some implementations, with respect to the hanger arm pivot axis 28, the axial offset between the portion of the hanger 10 defining the axial extreme of the hanger 10 in the first axial direction and the portion of the hanger 10 defining the axial extreme of the hanger 10 in the second axial direction is a fourth distance D₄ in the use position 18 of the standoff 14 and the extended position 24 of the hanger arm 16, as illustrated in FIG. 1. In the illustrated embodiment, the third distance D₃ is less than the fourth distance D₄. In some embodiments, the third distance D₃ is less than or equal to half of the fourth distance D₄. In some embodiments, the third distance D₃ is less than or equal to a third of the fourth distance D₄. In some embodiments, the third distance D₃ is less than or equal to a quarter of the fourth distance D₄. In an exemplary embodiment of the hanger 10, the first distance D₁ is less than 2 inches (e.g., about 1.8 inches), the second distance D₂ is less than 7 inches (e.g., about 6.3 inches), the third distance D₃ is less than 1 inch (e.g., about 0.85 inches), and the fourth distance D₄ is less than 4 inches (e.g., about 3.5 inches).

Referring now to FIGS. 1-8, in operation of an exemplary embodiment of the hanger 10, a user may carry the hanger 10 into the woods with the standoff 14 in the stowed position 20 and the hanger arm 16 in the retracted position 26. In this configuration of the hanger 10, the footprint of the hanger 10 is relatively compact and may be conveniently stored within a pocket of the user. Upon ascending a tree within which the user intends to hunt, the user may then remove the hanger 10 from his pocket and pivot the standoff 14 from the stowed position 20 to the use position 18. With the standoff 14 in the use position 18, the user holds the hanger 10 against the tree, such that the ridges 54 of the standoff 14 and the ridges 54 of the rear side 32 of the support member 12 contact the trunk of the tree. The user then wraps a strap about the tree and inserts the strap into the slot 42 defined by the support member 12 and tightens the strap to secure the hanger 10 to the tree. Subsequently, the user pivots the hanger arm 16 from the retracted position 26 to the extended position 24 and hangs his bow on the support surface 68 of the hanger arm 16.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A hanger, comprising:
a support member;
a standoff pivotably coupled to the support member and operable to pivot relative to the support member between a use position and a stowed position about a standoff pivot axis; and
a hanger arm pivotably coupled to the support member and operable to pivot relative to the support member between an extended position and a retracted position about a hanger arm pivot axis.

2. The hanger of claim 1, wherein, with respect to the standoff pivot axis, the axial offset between the portion of the hanger defining the axial extreme of the hanger in a first axial direction and the portion of the hanger defining the axial extreme of the hanger in a second axial direction that is opposite the first axial direction is a first distance in the stowed position of the standoff and the retracted position of the hanger arm, and the axial offset between the portion of the hanger defining the axial extreme of the hanger in the first axial direction and the portion of the hanger defining the axial extreme of the hanger in the second axial direction is a second distance in the use position of the standoff and the extended position of the hanger arm, wherein the first distance is less than the second distance.

3. The hanger of claim 2, wherein the first distance is less than or equal to half of the second distance.

4. The hanger of claim 3, wherein the first distance is less than or equal to a third of the second distance.

5. The hanger of claim 4, wherein the first distance is less than or equal to a quarter of the second distance.

6. The hanger of claim 2, wherein, with respect to the hanger arm pivot axis, the axial offset between the portion of the hanger defining the axial extreme of the hanger in a first axial direction and the portion of the hanger defining the axial extreme of the hanger in a second axial direction that is opposite the first axial direction is a third distance in the stowed position of the standoff and the retracted position of the hanger arm, and the axial offset between the portion of the hanger defining the axial extreme of the hanger in the first axial direction and the portion of the hanger defining the axial extreme of the hanger in the second axial direction is a fourth distance in the use position of the standoff and the extended position of the hanger arm, wherein the third distance is less than the fourth distance.

7. The hanger of claim 6, wherein the third distance is less than or equal to half of the fourth distance.

8. The hanger of claim 7, wherein the third distance is less than or equal to a third of the fourth distance.

9. The hanger of claim 8, wherein the third distance is less than or equal to a quarter of the fourth distance.

10. The hanger of claim 1, wherein the standoff pivot axis is not parallel to the hanger arm pivot axis.

11. The hanger of claim 10, wherein the standoff pivot axis is perpendicular to the hanger arm pivot axis.

12. The hanger of claim 11, wherein the support member defines a slot configured to receive a strap therein for securing the hanger to a tree, and wherein the slot is defined on a side of the support member opposite a side of the support member on which the standoff is disposed, and the slot is aligned with the standoff, such that the standoff pivot axis extends through the slot.

13. The hanger of claim 12, wherein the support member includes a hook portion that is positioned downward of the hanger arm.

14. The hanger of claim 13, wherein the support member defines an aperture that is positioned downward of the slot and a channel that is positioned upward of the slot, wherein the aperture and the channel are configured to receive a cord therein.

15. A hanger, comprising:
a support member having a rear side and a front side that is opposite the rear side and that defines a slot configured to receive a strap therein for securing the hanger to a tree;
a standoff pivotably coupled to the support member, extending rearward away from the rear side of the support member, and operable to pivot relative to the support member between a use position and a stowed position about a standoff pivot axis that extends through the slot; and
a hanger arm pivotably coupled to the support member and operable to pivot relative to the support member between an extended position and a retracted position about a hanger arm pivot axis.

16. The hanger of claim 15, wherein the standoff pivot axis is perpendicular to the hanger arm pivot axis.

17. A hanger, comprising:
a support member;
a standoff pivotably coupled to the support member and operable to pivot relative to the support member between a use position and a stowed position about a standoff pivot axis; and
a hanger arm pivotably coupled to the support member and operable to pivot relative to the support member between an extended position and a retracted position about a hanger arm pivot axis, wherein an uppermost portion of the support member is the uppermost portion of the hanger in the use position of the standoff and the extended position of the hanger arm, and the uppermost portion of the support member is lower than a portion of the standoff in the stowed position of the standoff and lower than a portion of the hanger arm in the retracted position of the hanger arm.

18. The hanger of claim 17, wherein the standoff pivot axis is perpendicular to the hanger arm pivot axis.

19. The hanger of claim 18, wherein, with respect to the standoff pivot axis, the axial offset between the portion of the hanger defining the axial extreme of the hanger in a first axial direction and the portion of the hanger defining the axial extreme of the hanger in a second axial direction that is opposite the first axial direction is a first distance in the stowed position of the standoff and the retracted position of the hanger arm, and the axial offset between the portion of the hanger defining the axial extreme of the hanger in the first axial direction and the portion of the hanger defining the axial extreme of the hanger in the second axial direction is a second distance in the use position of the standoff and the extended position of the hanger arm, wherein the first distance is less than the second distance.

20. The hanger of claim 19, wherein with respect to the hanger arm pivot axis, the axial offset between the portion of the hanger defining the axial extreme of the hanger in a first axial direction and the portion of the hanger defining the axial extreme of the hanger in a second axial direction that is opposite the first axial direction is a third distance in the stowed position of the standoff and the retracted position of the arm, and the axial offset between the portion of the hanger defining the axial extreme of the hanger in the first axial direction and the portion of the hanger defining the axial extreme of the hanger in the second axial direction is a fourth distance in the use position of the standoff and the extended position of the hanger arm, wherein the third distance is less than the fourth distance.
